(19) United States
(12) Patent Application Publication
(10) Pub. No.: US 2009/0095324 A1
(43) Pub. Date: Apr. 16, 2009

(54) METHOD OF REMOVING A RESIDUAL MATERIAL FROM A CONDUIT

(75) Inventors: Nicholas John Crowther, West Yorkshire (GB); Donald Eagland, West Yorkshire (GB)

Correspondence Address: MICHAEL BEST & FRIEDRICH LLP, 100 E WISCONSIN AVENUE, Suite 3300, MILWAUKEE, WI, 53202, US

(73) Assignee: AGT Sciences Limited, Bradford (GB)

(21) Appl. No.: 12/298,660

(22) PCT Filed: Apr. 25, 2007
(86) PCT No.: PCT/GB07/01501

§ 371 Date: Oct. 27, 2008

(30) Foreign Application Priority Data
Apr. 27, 2006 (GB) 0608342.2

(51) Int. Cl. B08B 9/032

(52) U.S. Cl. 134/22.14

(57) ABSTRACT

An underground cable (2) comprises a housing (4) filled with conductive elements (6) and an insulating oil (12). To remove the insulating oil and prevent contamination, a visco-elastic formulation is prepared, suitably from cross-linked polyvinylalcohol, and introduced into the cable (2). The fluid is forced through the cable whereby it removes insulating oil therefrom.

This invention relates to conduits and particularly, although not exclusively, relates to the removal of residual materials from conduits such as pipes or cables. Preferred embodiments relate to removal of residual materials from power cables, especially such cables situated underground.

It is well-known to bury underground long lengths of cables for transmission of a.c. electric power. In general terms, known cables may comprise an electrical conductor which is a metal and an electrically insulating layer being wound around the conductor. The insulating layer may comprise paper or another porous material which is impregnated with insulating oil. The oil may be an aromatic hydrocarbon, preferably an alkylbenzene with dodecylbenzene being a specific example thereof.

After the useful lifetime of the cables has passed, the cables are simply left underground. However, it is found that the aromatic hydrocarbon leaches out of the cables over time and this is environmentally unacceptable.

A technology exists for cleaning underground cables by pumping compressed air into the cables to blow insulating oil from them. However, even after such treatment, a substantial amount of residual oil remains.

Similarly, pipes which may have carried toxic chemicals are, after their useful lifetime, left underground. However, again, there is a risk that toxic chemicals may leach from the pipes, for example if the pipes become broken or cracked, leading to the contamination of the surrounding area.

It is an object of the invention to address the above-described problems.

According to a first aspect of the invention, there is provided a method of removing a residual material from a conduit, the method comprising introducing an aqueous formulation of a water-soluble polymer which is optionally cross-linked into the conduit to contact residual material in the conduit and cause it to move from a first location to a second location.

Examples of water-soluble polymers include the following: water soluble gums, for example gum arabic, karaya gum, tragacanth gum, ghatti gum, guar gum; soybean derivatives, for example locust bean gum, tamarind gum; water soluble biopolymers, for example dextran, xanthan gum; water soluble proteins, for example gelatin type materials, carrageenan, agar and alginates, animal derivatives, casein, pectin; starch and starch derivatives, for example starch, modified starch, starch derivatives; cellulose derivatives, for example methyl cellulose, carboxymethyl cellulose, hydroxyethyl cellulose, hydroxypropyl cellulose; polyvinyls and maleic anhydride copolymers, for example polyvinyl alcohol, polyvinyl pyrrolidone; miscellaneous water soluble polyvinyls, for example maleic anhydride copolymers; polyacrylates and related systems, for example polyacrylates, polyacrylamides; polyimines and related systems, for example polyethylene oxides, polyethylenimines, polyethylene glycols; surface active water soluble polymers, for example lignosulfonates and related materials, lignites, tannins.

Preferably, said water-soluble polymer includes a functional group selected from an alcohol, carboxylic acid, carboxylic acid derivative, for example an ester, and an amine group. Said polymer preferably includes a backbone comprising, preferably consisting essentially of carbon atoms. The backbone is preferably saturated. Pendent from the backbone is suitably one or more said functional groups described. Said polymer may have a number average molecular weight (Mn) of at least 10,000, preferably at least 50,000, especially at least 75,000. Mn may be less than 500,000, preferably less than 400,000. Said polymer is preferably a polyvinyl polymer. Preferred polymers include optionally substituted, preferably unsubstituted, polyvinylalcohol, polyvinylacetate, polyalkylene glycols, for example polypropylene glycol, and collagen (and any component thereof) and of these polyvinylalcohol and/or polyvinylacetate based polymers are preferred. Examples of substituted polymers include polyvinylalcohol polymers which have been modified with hydrocarbon groups. Such polymers may be used in the method without them being cross-linked.

In one embodiment, preferred water-soluble polymers comprise a polymeric material AA which includes —O— moieties pendent from a polymeric backbone thereof. Said polymeric backbone of polymeric material AA preferably includes carbon atoms. Said carbon atoms are preferably part of —CH₂— moieties. Preferably, a repeat unit of said polymeric backbone includes carbon to carbon bonds, preferably C—C single bonds. Preferably, said polymeric material AA includes a repeat unit which includes a —CH₂— moiety. Preferably, said polymeric backbone does not include any —O— moieties, for example —C—O— moieties such as are found in an alkyleneoxy polymer, such as polyethyleneglycol. Said polymeric backbone is preferably not defined by an aromatic moiety such as a phenyl moiety such as is found in polyethersulphones. Said polymeric backbone preferably does not include any —S— moieties. Said polymeric backbone preferably does not include any nitrogen atoms. Said polymeric backbone preferably consists essentially of carbon atoms, preferably in the form of C—C single bonds. Said —O— moieties are preferably directly bonded to the polymeric backbone. Said polymeric material AA preferably includes, on average, at least 10, more preferably at least 50, —O— moieties pendent from the polymeric backbone thereof. Said —O— moieties are preferably a part of a repeat unit of said polymeric material AA. Preferably, said —O— moieties are directly bonded to a carbon atom in said polymeric backbone of polymeric material AA, suitably so that said polymeric material AA includes a moiety (which is preferably part of a repeat unit) of formula:

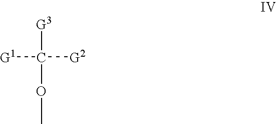

where G¹ and G² are other parts of the polymeric backbone and G³ is another moiety pendent from the polymeric backbone. Preferably, G³ represents a hydrogen atom.

Preferably, said polymeric material AA includes a moiety

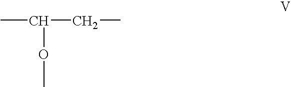

Said moiety V is preferably part of a repeat unit. Said moiety V may be part of a copolymer which includes a repeat unit which includes a moiety of a different type compared to moiety V. Suitably, at least 60 mole %, preferably at least 80 mole %, more preferably at least 90 mole % of polymeric material AA comprises repeat units which comprise (preferably consists of) moieties V. Preferably, said polymeric material AA consists essentially of repeat units which comprise (preferably consist of) moieties V.

Suitably, at least 60 mole %, preferably at least 80 mole %, more preferably at least 90 mole %, especially substantially all of said polymeric material AA comprises vinyl moieties which are optionally cross-linked.

Preferably, the free bond to the oxygen atom in the —O— moiety pendent from the polymeric backbone of polymeric material AA (and preferably also in moieties IV and V) is bonded to a group R¹⁰ (so that the moiety pendent from the polymeric backbone of polymeric material AA is of formula —O—R¹⁰) Preferably group R¹⁰ comprises fewer than 10, more preferably fewer than 5, especially 3 or fewer carbon atoms. It preferably only includes atoms selected from carbon, hydrogen and oxygen atoms. R¹⁰ is preferably selected from a hydrogen atom and an alkylcarbonyl, especially a methylcarbonyl group. Preferably moiety —O— R¹⁰ in said polymeric material AA is an hydroxyl or acetate group.

Said polymeric material AA may include a plurality, preferably a multiplicity, of functional groups (which incorporate the —O— moieties described) selected from hydroxyl and acetate groups. Said polymeric material AA preferably includes a multiplicity of hydroxyl groups pendent from said polymeric backbone. Said polymeric material AA preferably includes a multiplicity of acetate groups pendent from the polymeric backbone.

Preferably, each free bond to the oxygen atoms in —O— moieties pendent from the polymeric backbone in polymeric material AA, except for any free bonds which are involved in cross-linking the polymeric material AA, is of formula —O—R¹⁰ wherein each group —OR¹⁰ is selected from hydroxyl and acetate.

Preferably, said polymeric material AA includes a vinyl alcohol moiety, especially a vinyl alcohol repeat unit. Said polymeric material AA preferably includes a vinyl acetate moiety, especially a vinylacetate repeat unit. Polyvinylalcohol is generally made by hydrolysis of polyvinylacetate. Said polymeric material AA may comprise a 0-100% hydrolysed, preferably a 5 to 95% hydrolysed, more preferably a 60 to 90wt %, especially a 70 to 90wt % hydrolysed polyvinylacetate

Said polymeric material AA may have a number average molecular weight (Mn) of at least 10,000, preferably at least 50,000, especially at least 75,000. Mn may be less than 500,000, preferably less than 400,000. Said polymeric material AA is preferably a polyvinyl polymer. Said polymeric material AA may be a copolymer.

Said polymeric material AA is preferably a polyvinyl alcohol polymer or copolymer.

Said polymeric material AA may be a random or block copolymer.

In one embodiment, said water-soluble polymer may not be cross-linked. For example a non-cross-linked water-soluble polymer, for example a non-cross-linked poly(vinylalcohol) may be used. In a preferred embodiment, however, said water-soluble polymer is cross-linked. It may be cross-linked by a cross-linking material which, at least prior to cross-linking said water-soluble polymer, includes a functional group which is able to react in the presence of said water-soluble polymer to define a cross-linked polymer.

Said cross-linking material and said water-soluble polymer may be arranged to undergo a condensation reaction to define a cross-linked polymer.

Said cross-linking material may be an aldehyde, carboxylic acid, urea, acroleine, isocyanate, vinyl sulphate or vinyl chloride of a diacid or include any functional group capable of reacting, for example condensing, with one or more groups on said water-soluble polymer, for example poly(vinylalcohol). Examples of the aforementioned include formaldehyde, acetaldehyde, glyoxal and glutaraldehyde, as well as maleic acid, oxalic acid, dimethylurea, polyacroleines, diisocyanates, divinyl sulphate and the chlorides of diacids.

Said cross-linking material is preferably an aldehyde containing or generating compound. Preferably, said cross-linking material is an aldehyde containing compound.

Said cross-linking material may include one or more aldehyde groups. Whilst it could be a monoaldehyde such as formaldehyde it preferably includes a plurality of aldehyde groups.

Said cross-linking material may have a general formula

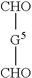

where G⁵ represents a direct link or a linking moiety.

G⁵ may be arranged to space apart the —CHO groups thereby to affect the spacing of the cross-linking of the water-soluble polymer.

In one embodiment, group G⁵ may be a —(CH₂)_{y}— moiety wherein y represents 0 to 8, and one or more of the H atoms may be replaced by (but preferably are not replaced by) another atom or group. Preferably, y represents 0 to 6, more preferably 0 to 4, especially 0 to 2.

Group G⁵ may be arranged to introduce some rigidity into the cross-linking of the water-soluble polymer. For example, group G⁵ may include at least some covalent bonds which are not freely rotatable. For example, group G⁵ preferably does not consist exclusively of a —CH₂— chain wherein each carbon-carbon bond will be freely rotatable but preferably includes an atom or group or other means which restricts free rotation compared to a case wherein G⁵ consists of a —CH₂— chain. For example G⁵ may incorporate bulky atoms or groups; and/or unsaturated atoms or groups; and/or atoms or groups which hinder free rotation due to electronic effects.

Group G⁵ may include at least 1, preferably at least 2, more preferably at least 3, especially at least 4, carbon atoms in a chain extending between the two —CHO groups.

In one embodiment, group G⁵ incorporates one or more aromatic or heteroaromatic groups. Such groups may be arranged to restrict rotation as described. Preferred heteroaromatic groups include N-containing heteroaromatic groups. Preferred aromatic and heteroaromatic groups are selected from optionally-substituted phenyl and N-containing aromatic groups, such as pyridinyl groups.

Group G⁵ preferably includes both an aromatic and N-containing heteroaromatic group.

Group G⁵ preferably includes some charge separation. It preferably includes a polar group. It preferably includes a cationic group. A preferred cationic group is one which includes a N⁺ moiety.

Group G⁵ may itself include one or more aldehyde (or other) functional groups.

Said cross-linked water-soluble polymer may include a moiety

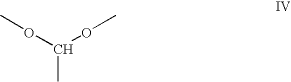

wherein the free bonds of the oxygen atoms are bonded to a polymeric backbone and the free bond of the carbon atom is bonded to a residue of said cross-linking material. The residue of said cross-linking material may also be bonded to the polymeric backbone of another polymeric chain (for example of a said water-soluble polymer as described), thereby to cross-link said water-soluble polymer.

Said cross-linking material is preferably polar. It may be ionic. It may include a sulphonate anion. It may include a heteroaromatic moiety. It may include a quaternary ammonium moiety, for example a C₅H₅N⁺-moiety. Methyl sulphate is an example of a counterion but other counterions could be used.

Said cross-linking material may comprise:

(i) a first polymeric material having a repeat unit of formula

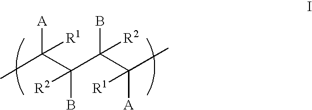

wherein A and B are the same or different, are selected from optionally-substituted aromatic and heteroaromatic groups and at least one comprises a relatively polar atom or group and R¹ and R² independently comprise relatively non-polar atoms or groups; or

(ii) a first polymeric material prepared or preparable by providing a compound of general formula

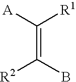

wherein A, B, R¹ and R² are as described above, in an aqueous solvent and causing the groups C═C in said compound to react with one another to form said cross-linking polymer.

In said cross-linking polymer described above, A and/or B could be multi-cyclic aromatic or heteroaromatic groups. Preferably, A and B are independently selected from optionally-substituted five or more preferably six-membered aromatic and heteroaromatic groups. Preferred heteroatoms of said heteroaromatic groups include nitrogen, oxygen and sulphur atoms of which oxygen and especially nitrogen, are preferred. Preferred heteroaromatic groups include only one heteroatom. Preferably, a or said heteroatom is positioned furthest away from the position of attachment of the heteroaromatic group to the polymer backbone. For example, where the heteroaromatic group comprises a six-membered ring, the heteroatom is preferably provided at the 4-position relative to the position of the bond of the ring with the polymeric backbone.

Preferably, A and B represent different groups. Preferably, one of A or B represents an optionally-substituted aromatic group and the other one represents an optionally-substituted heteroaromatic group. Preferably A represents an optionally-substituted aromatic group and B represents an optionally-substituted heteroaromatic group especially one including a nitrogen heteroatom such as a pyridinyl group.

Unless otherwise stated, optionally-substituted groups described herein, for example groups A and B, may be substituted by halogen atoms, and optionally substituted alkyl, acyl, acetal, hemiacetal, acetalalkyloxy, hemiacetalalkyloxy, nitro, cyano, alkoxy, hydroxy, amino, alkylamino, sulphinyl, alkylsulphinyl, sulphonyl, alkylsulphonyl, sulphonate, amido, alkylamido, alkylcarbonyl, alkoxycarbonyl, halocarbonyl and haloalkyl groups. Preferably, up to 3, more preferably up to 1 optional substituents may be provided on an optionally substituted group.

Unless otherwise stated, an alkyl group may have up to 10, preferably up to 6, more preferably up to 4 carbon atoms, with methyl and ethyl groups being especially preferred.

Preferably, A and B each represent polar atoms or group—that is, there is preferably some charge separation in groups A and B and/or groups A and B do not include carbon and hydrogen atoms only.

Preferably, at least one of A or B includes a functional group which can undergo a condensation reaction, for example on reaction with said water-soluble polymer.

Preferably, A includes a said functional group which can undergo a condensation reaction.

Preferably, one of groups A and B includes an optional substituent which includes a carbonyl or acetal group with a formyl group being especially preferred. The other one of groups A and B may include an optional substituent which is an alkyl group, with an optionally substituted, preferably unsubstituted, C₁₋₄ alkyl group, for example a methyl group, being especially preferred.

Preferably, A represents a group, for example an aromatic group, especially a phenyl group, substituted (preferably at the 4-position relative to polymeric backbone when A represents an optionally-substituted phenyl group) by a formyl group or a group of general formula

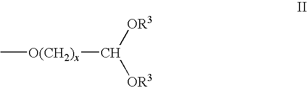

where x is an integer from 1 to 6 and each R³ is independently an alkyl or phenyl group or together form an alkalene group.

Preferably, B represents an optionally-substituted heteroaromatic group, especially a nitrogen-containing heteraromatic group, substituted on the heteroatom with a hydrogen atom or an alkyl or aralkyl group. More preferably, B represents a group of general formula

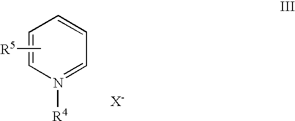

wherein R⁴ represents a hydrogen atom or an alkyl or aralkyl group, R⁵ represents a hydrogen atom or an alkyl group and X⁻ represents a strongly acidic ion.

Preferably, R¹ and R² are independently selected from a hydrogen atom or an optionally-substituted, preferably unsubstituted, alkyl group. Preferably, R¹ and R² represent the same atom or group. Preferably, R¹ and R² represent a hydrogen atom.

Preferred cross-linking materials may be prepared from any of the compounds described on page 3 line 8 to line 39 of GB2030575B by the method described in WO98/12239 and the contents of the aforementioned documents are incorporated herein by reference.

Said cross-linking material may be of formula

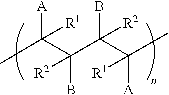

wherein A, B, R¹ and R² are as described above and n is an integer. Integer n is suitably 10 or less, preferably 8 or less, more preferably 6 or less, especially 5 or less. Integer n is suitably at least 1, preferably at least 2, more preferably at least 3.

A cross-linked polymer suitably includes a moiety of formula

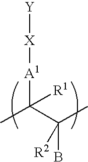

wherein R¹, R² and B are as described above, A¹ represents a residue of group A described above after the reaction involving said water-soluble polymer and said cross-linking material, Y represents a residue of said water-soluble polymer after said reaction involving said water-soluble polymer and said cross-linking material and X represents a linking atom or group extending between the residues of said water-soluble polymer and said cross-linking material. In one preferred embodiment A¹ represents an optionally-substituted phenyl group, X represents a group

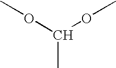

which is bonded via the oxygen atoms to a residue of said water-soluble polymer. For example, group X may be bonded to the polymeric backbone of said water-soluble polymer

The method of the first aspect may include the step of preparing an aqueous formulation as described. The method may include contacting a said water-soluble polymer and a said cross-linking material in the presence of water.

The ratio of the wt % of said cross-linking material to the wt % of said water-soluble polymer in said aqueous formulation, prior to any cross-linking reaction is suitably less than 0.15, preferably less than 0.10, more preferably 0.75 or less, especially 0.60 or less. Said ratio may be at least 0.02, preferably at least 0.04. Preferably, said ratio is in the range 0.04 to 0.06.

The sum of the wt % of the water-soluble polymer and said cross-linking material may be at least 1 wt %, preferably at least 1.5 wt %, more preferably at least 2 wt %. The sum may be less than 5 wt %, preferably less than 4 wt %, more preferably less than 3 wt %.

Said aqueous formulation may include at least 90 wt %, preferably at least 95 wt %, water.

Said aqueous formulation preferably includes a catalyst for catalysing the reaction of the water-soluble and said cross-linking material. Said catalyst is preferably a protic acid. Said acid preferably has an acid dissociation constant value of greater than 10⁻⁶, more preferably greater than 10⁻⁴ and, especially, greater than 10⁻². Said restrictor formulation suitably includes less than 2 wt %, preferably less than 1 wt %, especially less than 0.5 wt % of catalyst.

The pH of the aqueous formulation, suitably measured immediately prior to it being introduced into said conduit is suitably less than 6, preferably less than 4, more preferably less than 3. The pH is suitably greater than 1. The aforementioned protic acid included as a catalyst may be used to adjust the pH to the desired level.

Said aqueous formulation may include means for restricting the gelling of the formulation when the temperature of the formulation is less than 5° C. or less than 0° C. Said means for restricting may be for restriction gelling of the material after it has thawed from a frozen state.

Said aqueous formulation may include a material having one or more hydroxyl moieties for restricting gelling of the formulation, for example upon and/or after freezing. Said material preferably includes at least two hydroxyl groups. Said material may be a polymer. The polymer may have a molecular weight of at least 100, preferably at least 200, more preferably at least 300. The molecular weight may be less than 2000, preferably less than 750, more preferably less than 500. Said material may include ether moieties, for example in the polymeric backbone thereof. Said material is preferably a glycol, for example a polyethylene glycol.

In the method of the first aspect, said conduit is preferably a cable, for example a power cable. Said cable may comprise an electrical conductor and an insulating means.

Said conduit, for example said cable, may contain a residual material which suitably needs to be removed. Said residual material may be a component of said insulating means. Said residual material may comprise an oil, for example an insulating oil.

Said residual material may comprise an alkyl benzene, for example dodecylbenzene.

Said conduit may have a diameter of at least 1 cm, preferably at least 2 cm and a length of at least 10 m, preferably at least 50 m.

Said conduit is preferably buried underground for example at a depth (at least in part) of at least 20 cm, preferably at least 50 cm.

Said aqueous formulation is preferably pumped into the conduit. It is preferably arranged to travel within the conduit from a first part thereof, for example a first end, to a second part thereof, for example a second end thereof. Said aqueous formulation may be pumped a distance of at least 5 cm, preferably at least 10 m, along the conduit.

Said aqueous formulation may have a viscosity in the range 5 to 15 cp measured at a shear rate of 100 s⁻¹ when it is introduced into the conduit. The formulation is suitably visco-elastic.

Said aqueous formulation preferably releases residual material from parts of the conduit and pushes the residual material towards the second location.

At the second location, residual material may exit the conduit and be collected. Aqueous formulation which has passed through the conduit may also be collected at the second location. It may be possible to re-use the collected aqueous formulation either for passage through the same length of conduit or in a further length of conduit.

At the second location, residual material may be collected and brought to the surface. It may then be transported to a remote location for treatment.

After residual material has been removed from the conduit, said conduit may be sealed. In one embodiment, it may be sealed by introduction of a sealing formulation which is in the form of a gel which is arranged within and retained in the conduit. For example, a formulation may be introduced into the conduit which is arranged to gel within the conduit and become sufficiently rigid that it is substantially immovably retained therein. Said gel preferably comprises a cross-linked water-soluble polymer. It preferably comprises a hydrogel.

Said gel may comprise a water-soluble polymer as described in any statement herein cross-linked by a cross-linking material as described herein.

Said gel may be prepared by contact of a said water-soluble polymer, especially poly(vinylalcohol) and a said cross-linking material, especially a first polymeric material of formula I. To prepare a gel, the ratio of the wt % of said cross-linking material to the wt % of said water-soluble polymer in the aqueous formulation may be at least 0.05 and may be 0.2 or less.

According to a second aspect of the invention, there is provided an assembly comprising a receptacle containing an aqueous formulation of a water-soluble polymer which is optionally cross-linked and a conduit which includes residual material wherein said receptacle is in fluid communication with said conduit for passage of fluid from the receptacle into the conduit.

The assembly may include means for collecting fluid which exits the conduit at a second location spaced from a first location at which fluid is introduced into the conduit from said receptacle.

Said receptacle may have a volume of at least 1001, preferably at least 10001, more preferably at least 50001.

Said assembly may include pump means for pumping fluid from the receptacle into the conduit. The pump means may be arranged to pump fluid at a pressure of at least 10 psi, more preferably at least 20 psi, especially at least 30 psi.

The assembly preferably includes means for collecting fluid after passage through said conduit.

According to a third aspect of the invention, there is provided a receptacle containing a residue removed from a conduit, for example an alkylbenzene, and a water-soluble polymer which is optionally cross-linked.

The receptacle may be associated with a vehicle for transportation of the fluid contained therein.

Any feature of any aspect of any invention or embodiment described herein may be combined with any feature of any aspect of any other invention described herein mutatis mutandis.

Specific embodiments of the invention will now be described by way of example with reference to the accompanying diagrammatic drawings, in which:

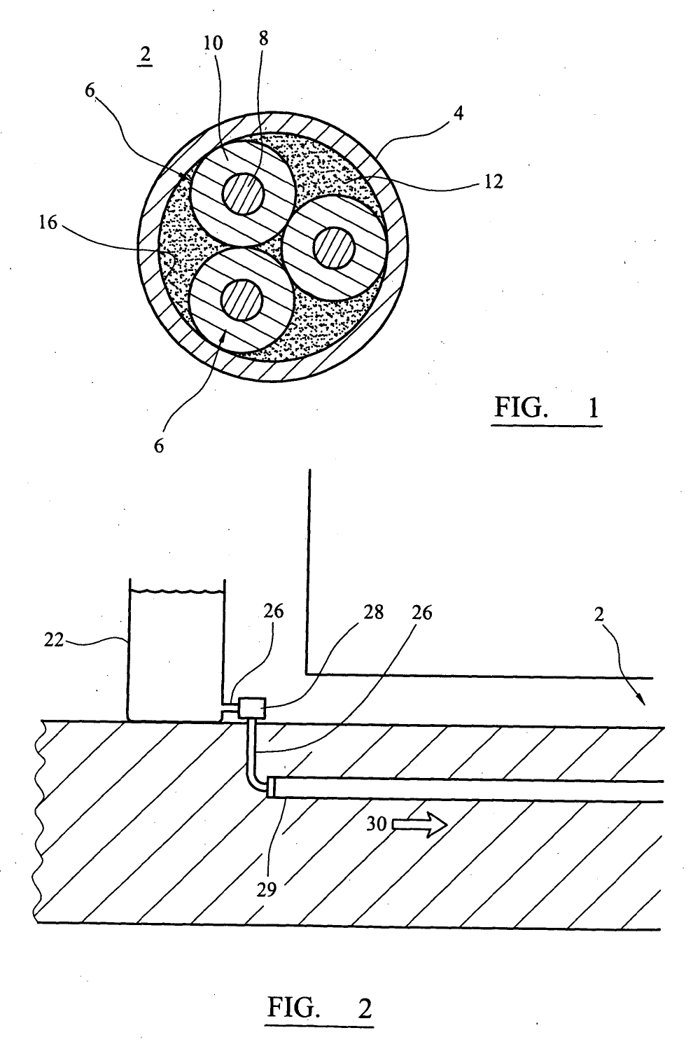

FIG. 1 is a cross-section through a cable; and

FIG. 2 shows part of a cable underground.

Referring to FIG. 1, a cable 2 which is buried underground comprises a housing 4 which may comprise an iron pipe or other metal structure within which conductive elements 6 are arranged. The conductive elements 6 include a stranded wire conductor 8 around which is wound a porous paper layer 10. The housing 4 is filled with a multiplicity of elements 6 which abut one another. Only three elements are shown in FIG. 1 although it will be appreciated that more elements may be enclosed within the housing. The housing also contains an insulating oil 12, for example comprising an alkylbenzene such as dodecylbenzene, which fills the housing and impregnates the layers 10 of elements 6. Many miles of cable 2 may be arranged under the ground 20 as illustrated in FIG. 2.

After the cable is no longer operative it is desirable to remove the alkylbenzene to prevent contamination of the ground 20. This may be achieved as described in Examples 3 and 4 below. Materials used in the examples may be prepared as described in Examples 1 and 2.

### EXAMPLE 1

### Preparation of Poly(vinylalcohol) Solution

A 2 wt % poly(vinylalcohol) solution was prepared by slowly stirring a known amount of water and adding a known amount of 88% hydrolysed poly(vinylalcohol) of molecular weight 300,000 to the stirred water. The suspension was stirred for 1 hour and, thereafter, the suspension was heated at a temperature of 60° C. until the suspended particles dissolved and the solution was clear. The solution was then allowed to cool to less than 5° C. and maintained at this temperature until used.

### EXAMPLE 2

### Preparation of Poly (1,4-di(4-(N-methylpyridinyl))-2,3-di(4-(1-formylphenyl)butylidene

This was prepared as described in Example 1 of PCT/GB97/02529, the contents of which are incorporated herein by reference. In the method, an aqueous solution of greater than 1 wt % of 4-(4-formylphenylethenyl)-1-methylpyridinium methosulphonate (SbQ) is prepared by mixing the SbQ with water at ambient temperature. Under such conditions, the SbQ molecules form aggregates. The solution was then exposed to ultraviolet light. This results in a photochemical reaction between the carbon-carbon double bonds of adjacent 4-(4-formylphenylethenyl)-1-methylpyridinium methosulphate molecules (I) in the aggregate, producing a polymer, poly (1,4-di(4-(N-methylpyridinyl))-2,3-di(4-(1-formylphenyl)butylidene methosulphonate (II).

### EXAMPLE 3

### Preparation of Visco-Elastic Cleaning Formulation

A 2 wt % solution comprising the poly(vinylalcohol) of Example 1 and the butylidene of Example 2 was prepared by addition of the butylidene polymer to a poly(vinylalcohol) solution, with mixing. The ratio of weight of poly(vinylalcohol) to butylidene polymer was 1 to 20. To this mixture was added sufficient paratoluene sulphonic acid (PTSA) or hydrochloric acid to lower the pH to 2.5. As a result a reaction starts between the poly(vinylalcohol) and butylidene polymer whereby the butylidene cross-links the polyvinylalcohol and a visco-elastic fluid is produced. The cross-linking reaction is summarised below.

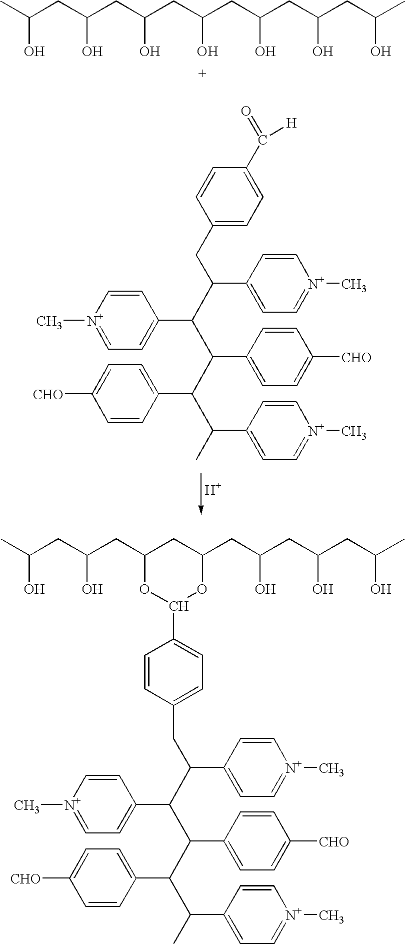

### EXAMPLE 4

### Cleaning of Cables using Visco-Elastic Formulation of Example 3

The visco-elastic formulation prepared as described in Example 3, is contained in a receptacle 22 above ground level 24. The reservoir is connected via pipe 26 to an end 29 of the cable 2 which has already been treated using a compressed air jet to force some of the oil in the cable out thereof. A pump 28 is arranged to pump formulation along pipe 26 from the receptacle 22 into the cable 2 so as to force the remaining insulation oil 12 along the cable in the direction of arrow 30. Oil may in fact be forced into ducts (not shown) defined in the cable which ducts extend from one end of the cable to the other. By pushing the formulation through the cable slowly enough, the formulation is able to push the alkylbenzene from the cable, with there being only a slight amount of mixing at the interface between the two. The formulation has a dual role—firstly, because of its visco-elastic nature, it is able to facilitate application of hydraulic pressure to the insulator oil to force it through the cable 20; and, secondly, it helps release the oil from the parts of the cable by reducing interfacial tension for example to release oil from paper layer 10 and inside surface 16 of the housing 4. Thus, after the formulation has passed through an area of the cable 2, the concentration of insulating oil remaining in the area is reduced to a negligible level.

In a collection region of cable 2, downstream of end 29, the formulation and the insulating oil are collected. Collection may be undertaken a distance of greater than 10 m, greater than 50 m or greater than 500 m from end 29. The fluid collected may be brought to the surface and then transported to a suitable location for processing. Provided the formulation is caused to move through the cable slowly enough to avoid turbulent mixing at the interface between the formulation and the oil, then, on collection, the formulation and oil form two layers with very little mixing at the interface.

In order to ensure a length of cable 2 has been treated sufficiently to remove the maximum amount of oil, the fluid collected may be analysed periodically. When the fluid is found to have a very low (and/or no) oil in it, then pumping of the fluid from receptacle 22 may be terminated.

### EXAMPLE 5

### Forming Rigid Gel in a Cable

Water (95.5 pbw) at ambient temperature (about 25° C.) was stirred at a low rate (to prevent foaming) and and the poly(vinylalcohol) referred to in Example 1 was added, so as to provide 4.5 pbw poly(vinylalcohol.) in solution. The butylidene polymer of Example 2 (0.4 pbw) was added and stirring continued without a pause. After dissolution of copolymer and the butylidene polymer, paratoluene sulphonic acid (PTSA) was added to pH 2.5 and thoroughly mixed into the formulation. This formulation had a viscosity of 10-20 cP. The amount of acid added affects the rate at which the poly(vinylalcohol) and butylidene polymer react as described below. The amount may be select according to how long is required to place the solution in a cable.

After addition of the acid, a gelling reaction starts. The formulation described takes about 4.5 hours at 25° C. to produce a solid gel.

The gelling reaction is as described above in Example 3.

The formulation prepared as described (before any significant gelling) may be pumped from a receptacle 22 into a cable 2 as described with reference to Example 4. However, in this case, the formulation is pumped at a sufficiently high rate to give at least some turbulent flow, so that any traces of oil are emulsified by the formulation and held in the gel formed. Once the cable has been filled with formulation pumping of further formulation from receptacle 22 may be stopped. Consequently, the cable remains filled with formulation. Eventually, the formulation becomes a rigid gel which fills the cable and encapsulates any oil therein. The oil is thereby held in position and is not believed to represent an environmental hazard.

The amounts and/or identity of the components of the formulation of Example 5 may be varied to affect the formation and properties of the gel, as follows:

(a) Butylidene polymer—increasing the concentration of the polymer used tends to shorten the time for the formulation to form a gel. It is preferred to use a butylidene polymer concentration of 10 wt % or less of the amount of polyvinylalcohol in the formulation since higher butylidene polymer concentrations tend to make the gel formed brittle.

(b) Polyvinylalcohol—the concentration affects the time for the formulation to form a gel and the final gel strength. The formulation preferably has a total polyvinylalcohol concentration of 5 wt % or less. If the concentration of polyvinylalcohol in the formulation is too high, the gel tends to form too quickly and also the initial viscosity is likely to be too high for easy pumping.

Additionally, the molecular weight of the poly(vinylalcohol) copolymer affects the initial viscosity of the formulation. For example if only a single type of 88% hydrolysed poly(vinylalcohol) which has a relatively low molecular weight (e.g. about 100,000) is used, then the initial viscosity of the formulation prepared may be relatively low. However, if a high molecular weight material is used (e.g. of greater than 300,000) the initial viscosity of the formulation will be higher. By selection of one of more polyvinylalcohols of appropriate molecular weight, the viscosity (and hence ease of pumping) of the formulation may be varied over a wide range.

(c) Catalyst—This catalyses the reaction of the butylidene polymer and polyvinylalcohol. The amount and identify of the catalyst has consequences for gel strength and the time for the formulation to the gel. In general, increasing the amount of acid tends to increase the rate of formation of the gel; however, the gel may have reduced strength. Mineral acids such as hydrochloric acid may be used and these result in a relatively quick rate of production of gel, compared to PTSA which leads to a slower gelation reaction. In general the lower the pH of the formulation, the quicker the gelation reaction.

In addition, the formation and properties of the gel may be affected by the temperature and pressure during the gelation reaction. In general, increasing either of these parameters increases the rate of formation of the gel.

The formulation of Example 3 may be modified by addition of 0.5 wt % of a polyethylene glycol having a molecular weight of about 300. This prevents the formulation gelling after it has thawed from a frozen state. Consequently, when any frozen formulation thaws, it is sufficiently fluid to be pumped; otherwise if a gel forms after thawing, the gel may be too viscous even after thawing to enable it to be easily pumped through the conduit.

Thus, it should now be appreciated that the use of the formulations described enables cables to be cleaned and rendered relatively environmentally safe.

Whilst the specific embodiments describe treatment of cables, other types of conduits may be treated using the methods described.

1. A method of removing a residual material from a conduit, the method comprising introducing an aqueous formulation of a water-soluble polymer which is optionally cross-linked into the conduit to contact residual material in the conduit and cause it to move from a first location to a second location.

2. A method according to claim 1, wherein said polymer includes a backbone consisting essentially of carbon atoms and a functional group selected from an alcohol, carboxylic acid, carboxylic acid derivative and an amine group, pendant from the backbone.

3. A method according to claim 1, wherein said water-soluble polymer comprises a polymeric material AA which includes —O-moieties pendent from a polymeric backbone thereof.

4. A method according to claim 3, wherein said polymeric material AA includes a moiety

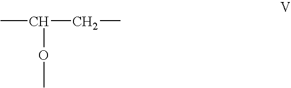

5. A method according to claim 4, wherein at least 60 mole % of polymeric material AA comprises a repeat units which comprise moieties V.

6. A method according to claim 4, wherein at least 60 mole % of said polymeric material AA comprises vinyl moieties which are optionally cross-linked.

7. A method according to claim 4, wherein said polymeric material AA includes a vinyl alcohol moieties.

8. A method according to claim 4, wherein said polymeric material AA is a polyvinyl alcohol polymer or copolymer which is optionally cross-linked.

9. A method according to claim 4, wherein said polymeric material AA is cross-linked.

10. A method according to claim 4, wherein said aqueous formulation includes a cross-linked water soluble polymer which comprises a polymeric material AA cross-linked using a cross-linking material of general formula 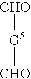
where G⁵ represents a direct link or a linking moiety.

11. A method according to claim 10, wherein G⁵ incorporates one or more aromatic or heteroaromatic groups.

12. A method according to claim 1, wherein said water-soluble polymer is cross-linked and includes a moiety 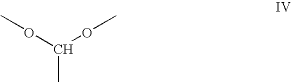
wherein the free bonds of the oxygen atoms are bonded to a polymeric backbone and the free bond of the carbon atom is bonded to a residue of a cross-linking material.

13. A method according to claim 10, wherein said cross-linking material comprises
(i) a first polymeric material having a repeat unit of formula 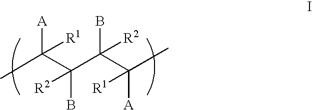
wherein A and B are the same or different, are selected from optionally-substituted aromatic and heteroaromatic groups and at least one comprises a relatively polar atom or group and R¹ and R² independently comprise relatively non-polar atoms or groups; or
(ii) a first polymeric material prepared or preparable by providing a compound of general formula 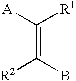
wherein A, B, R¹ and R² are as described above, in an aqueous solvent and causing the groups C═C in said compound to react with one another to form said cross-linking polymer.

14. A method according to claim 1, wherein the pH of the aqueous formulation immediately prior to it being introduced into said conduit is less than 6.

15. A method according to claim 1, wherein said conduit is a cable.

16. A method according to any preceding claim 1, wherein said conduit contains a residual material in need of removal, wherein said residual material comprises an insulating oil.

17. A method according to claim 16, wherein said residual material comprises an alkyl benzene.

18. A method according to claim 1, wherein said aqueous formulation is pumped into the conduit and arranged to travel within the conduit from a first end thereof to a second end thereof.

19. A method according to claim 1, which includes a further step of sealing said conduit after residual material has been removed, wherein said sealing comprises introduction of a sealing formulation which is in the form of a gel which is arranged within and retained in the conduit.

20. A method according to claim 19, wherein said gel is derived from a polyvinylalcohol polymer or copolymer.

21. An assembly comprising a receptacle containing an aqueous formulation of a water-soluble polymer which is optionally cross-linked and a conduit which includes residual material wherein said receptacle is in fluid communication with said conduit for passage of fluid from the receptacle into the conduit.

22. A receptacle containing a residue removed from a conduit, for example an alkylbenzene, and a water-soluble polymer which is optionally cross-linked.

23. A method of removing a residual material from a power cable, the method comprising introducing an aqueous formulation of optionally cross-linked polyvinylalcohol into the power cable to contact residual material in the power cable and cause it to move from a first location to a second location.

24. A method according to claim 23, wherein said residual material is an alkyl benzene.

25. A method according to claim 23, which comprises, after removal of residual material, sealing said power cable by introduction of a sealing formulation in the form of a gel which is arranged within and retained in the conduit.

26. A method according to claim 25, wherein said sealing formulation comprises a cross-linked polyvinylalcohol.
